(19) United States
(12) Patent Application Publication
(10) Pub. No.: US 2008/0302779 A1
(43) Pub. Date: Dec. 11, 2008

(54) Cooking Appliance Which is Mounted in an Elevated Manner

(75) Inventors: Ingo Bally, Traunstein (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Günter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosh und Siemens Hausgeräte GmbHü, München (DE)

(21) Appl. No.: 11/992,219

(22) PCT Filed: Sep. 15, 2006
(86) PCT No.: PCT/EP2006/066389

§ 371 Date: Mar. 18, 2008

(30) Foreign Application Priority Data
Sep. 19, 2005 (DE) 10 2005 044 698.1

(51) Int. Cl. A21B 1/00

(52) U.S. Cl. 219/396

(57) ABSTRACT

A cooking appliance which is mounted in an elevated manner, which comprises a muffle which defines a cooking chamber and which comprises a muffle opening which is arranged on the base thereof, a base door which is used to close the muffle opening and at least one heating body which is provided in the muffle, in addition to an associated operational method. The pyrolysis heating power, which is produced by the base door, does not exceed 20% of the pyrolysis heating power of all heating bodies for pyrolysis.

The present invention relates to a cooking appliance which is mounted in an elevated manner comprising a muffle defining a cooking compartment with a muffle opening on the base side, a base door for closing the muffle opening and at least one heating element present in the muffle, in addition to an associated operating method.

Cooking appliances comprising an oven cart which have pyrolytic self-cleaning are hitherto known. To this end, the cooking compartment and/or the muffle is heated up to high temperatures for a lengthy time, until residue in the muffle is incinerated. In this case, a top-heat element and/or a top-heat heating element and a bottom heat element and/or bottom-heat heating element are always activated. Optionally, heating of the surrounding air from a ring heating element may be activated by a circulating air motor in operation. The top heat element and the bottom heat element do not have to, or are not able to, output the same heating power but contribute substantially, i.e. not insignificantly, to the total pyrolysis heat output, i.e. to the heating power of all heating elements. Hitherto it has been accepted that, in particular the heating elements in the vicinity of the greatest soiling, i.e. typically on the floor and on lower side walls, should be activated for good cleaning results. In this regard, in particular with base doors with an integral heating area, said heating area has to provide a substantial contribution to the pyrolytic self-cleaning.

It has been shown for cooking appliances which are mounted in an elevated manner that, due to the restricted design, pyrolysis of the known type is disadvantageous for the operation and service life of an electronic unit in the base door. With base doors which are to be opened manually, the temperature of the base door may even rise above a user-friendly value. Reducing the nominal temperature during the pyrolysis, however, leads to unsatisfactory cleaning results.

It is the object of the present invention to provide a cooking appliance with the capacity for effective pyrolysis, in which the temperature of at least one base door may be kept relatively low.

The present object is achieved by a cooking appliance as claimed in claim 1 and a method as claimed in claim 14. Advantageous embodiments may be derived from the sub-claims, either individually or in combination.

To this end, the cooking appliance which is mounted in an elevated manner for pyrolysis sets the (pyrolysis) heating power of the heating element(s) (if present) in the base door to a maximum of 20% of the (pyrolysis) heating power of all heating elements, which—according to the design of the cooking appliance—is negligible. The other heating elements present in the muffle may, for example, comprise the top-heat heating element as well as optionally a ring heating element, halogen radiation illumination etc., the combined heating power thereof not falling below the value of 80% of the pyrolysis heating power. The heating elements may be of single- or multi-circuit design. The invention also comprises base doors without heating elements.

The ratio of the pyrolysis heating power of the base door and/or the heating element (if present) of the base door relative to the muffle and/or to the heating elements of the muffle is initially set as an average for the entire pyrolysis operation, i.e. the pyrolysis heating power of the base door and/or of the associated heating elements is allowed briefly to rise above 20%.

Advantageously, with pulsing of the heating elements, the heating power ratios are also maintained during a corresponding heating cycle, i.e. the pyrolysis heating power per heating cycle (i.e. averaged over the heating cycle, which may last for example for 80 s) corresponds to the heating power ratio selected. During a heating cycle, due to pulsing settings, etc. the relative heating power may briefly deviate from the above ratio.

Advantageously, the selected heating power ratio is maintained at all times during the pyrolysis.

As a result of the reduced heating or non-existent heating of the heating elements of the base door, said base door is not heated to any great extent: sub-assemblies in the base door are not heated to a supercritical temperature, and even with a compact design, the outer surface of the base door remains able to be easily operated by a user. Although, frequently, food residue remains on the base door, it has been shown that said food residue is also completely incinerated when only the heating elements present in the muffle (i.e. not those in the base door) are activated. Glass ceramics is very clean. Food residue on other parts of the muffle is also completely incinerated.

For several designs it may be sufficient if, for the pyrolysis, the pyrolysis heating power of the heating elements present in the muffle is set to at least 90%, in particular at least 95%, of all those heating elements operated, corresponding to 10% and/or 5% of the heating elements (if present) of the base door. As a result, the heating of the base door is further reduced.

To achieve the object, it is most advantageous when heating elements present in the muffle are able to be exclusively activated for the pyrolysis. It has been possible to show that for standard designs, such a very effective pyrolysis (complete incineration in the cooking compartment) has also been achieved with even lower heating of the base door.

It is more advantageous if a top-heat heating element is exclusively activated for the pyrolysis. Alternatively, a top-heat heating element and a ring heating element and/or further heating elements may be activated for the pyrolysis.

An advantageous distribution of the hot air in the cooking compartment is achieved by activating a circulating air motor.

The maximum heating power at the time of the pyrolysis is advantageously between 3 and 4 KW, in particular 3.6 KW.

It is advantageous if the nominal temperature in the cooking compartment is at least 425° C., in particular 475° C. during the pyrolysis. In this case, a typical adjustment fluctuation is ±15° C.

It is advantageous for improved operational safety if the closed base door is locked during the pyrolysis.

The locking advantageously takes place by means of off-circuit switching (for example short-circuiting) of a drive motor with self-locking gear mechanism, in particular with a gear ratio of the gear mechanism of between 30:1 and 60:1. It has been shown that in this case the base door resists high opening forces (corresponding to a load of >20 kg) and thus is not able to be opened under normal conditions.

For example, for improved operational safety it is advantageous if the base door during heating is locked after reaching a first temperature threshold (for example 350° C.) and during cooling is unlocked after reaching a second temperature threshold (for example 200° C.). The temperature thresholds may be unequal or equal.

The pyrolysis may be set to different time intervals, for example 60 minutes, 75 minutes and 90 minutes.

For reaching the high temperatures necessary for the pyrolysis, it is advantageous if a vapor flap closes a vapor outlet from the cooking compartment during the pyrolysis.

At the start of the pyrolysis, the relevant heating elements may be operated at maximum pyrolysis heating power, until a nominal temperature is reached, in order to be operated then at reduced heating power for maintaining the nominal temperature.

The invention is described in more detail hereinafter with reference to the embodiments shown in the accompanying schematic figures, in which:

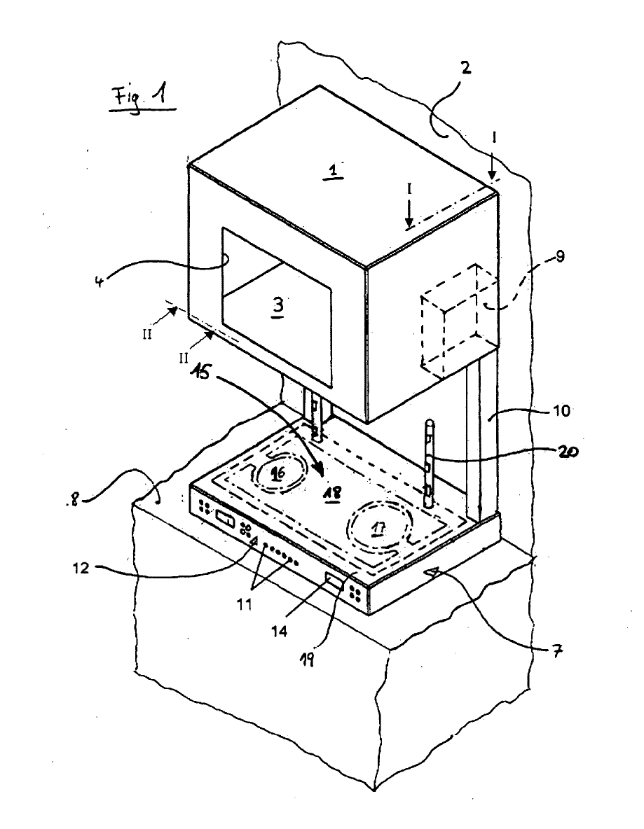

FIG. 1 shows a perspective view of a cooking appliance which is mounted in an elevated manner on a wall with the base door lowered;

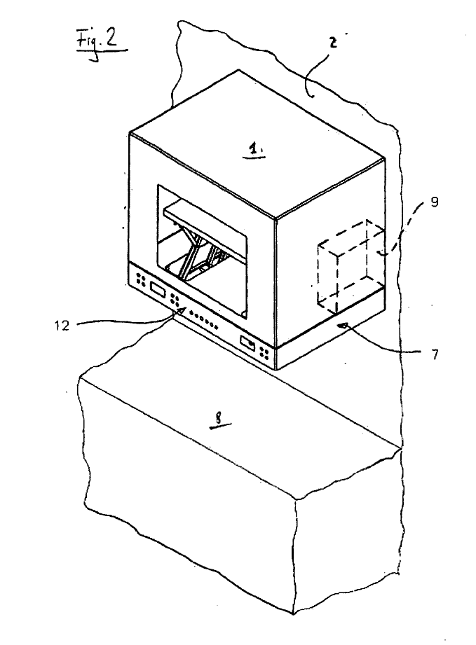

FIG. 2 shows a perspective view of the cooking appliance which is mounted in an elevated manner with the base door closed;

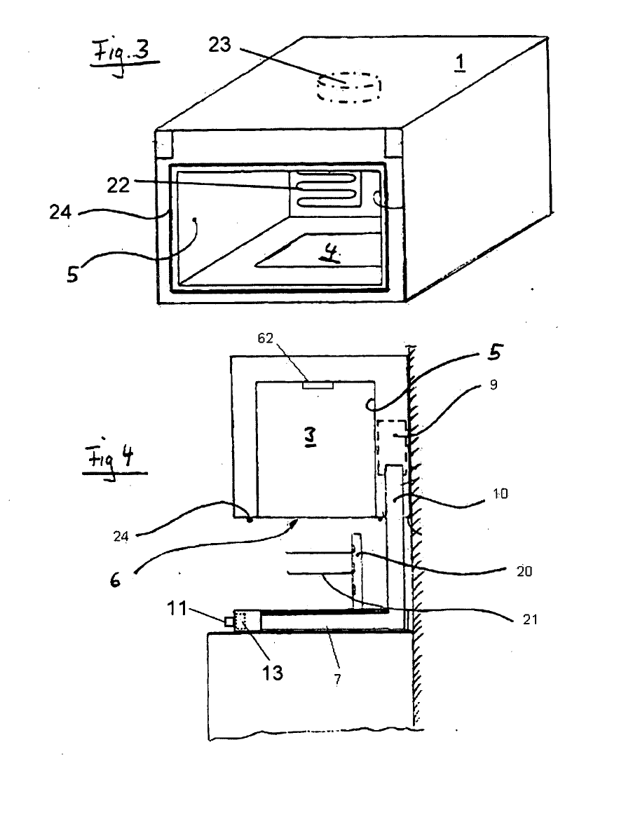

FIG. 3 shows a perspective view of a housing of the cooking appliance which is mounted in an elevated manner without the base door;

FIG. 4 shows a schematic side view in sectional view along the line I-I of FIG. 1 of the cooking appliance which is mounted in an elevated manner on the wall with the base door lowered;

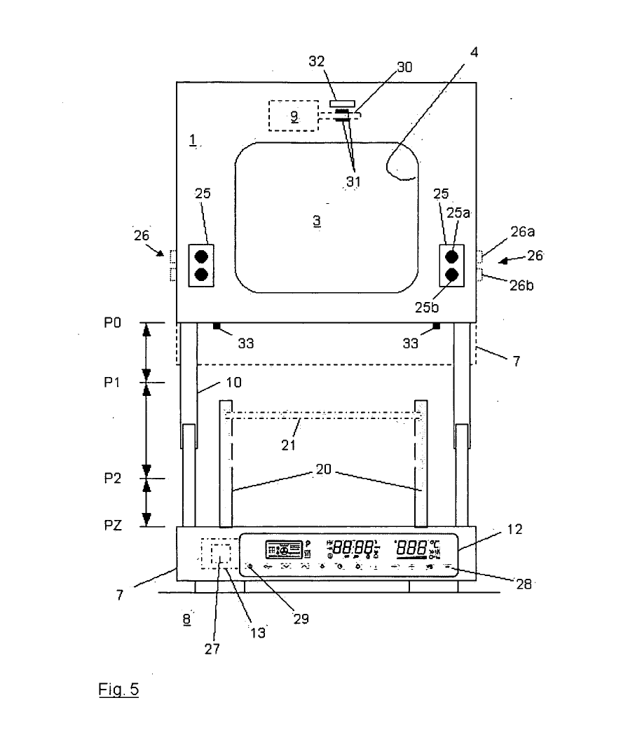

FIG. 5 shows a further embodiment of a cooking appliance which is mounted in an elevated manner in a front view;

FIG. 6 shows the embodiment of FIG. 5 in the closed state with a more accurate description of the position of individual housing elements in front view;

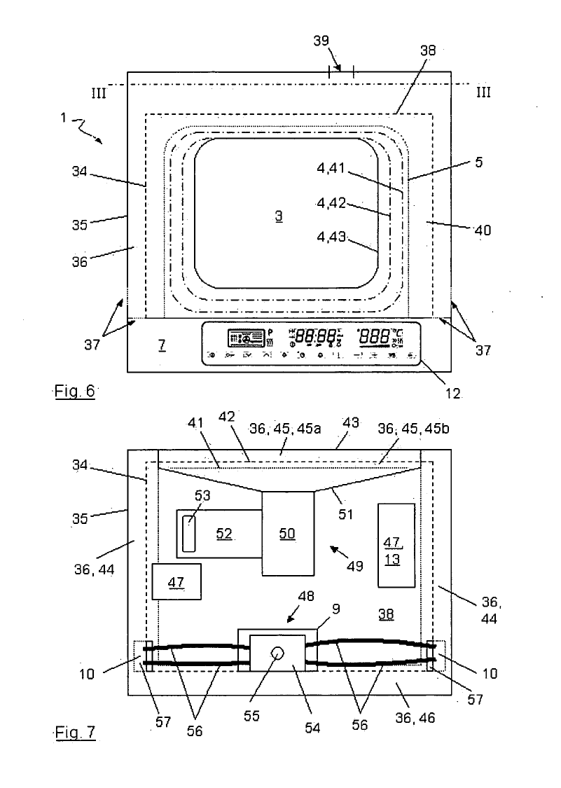

FIG. 7 shows a plan view in section of the embodiment of FIG. 6;

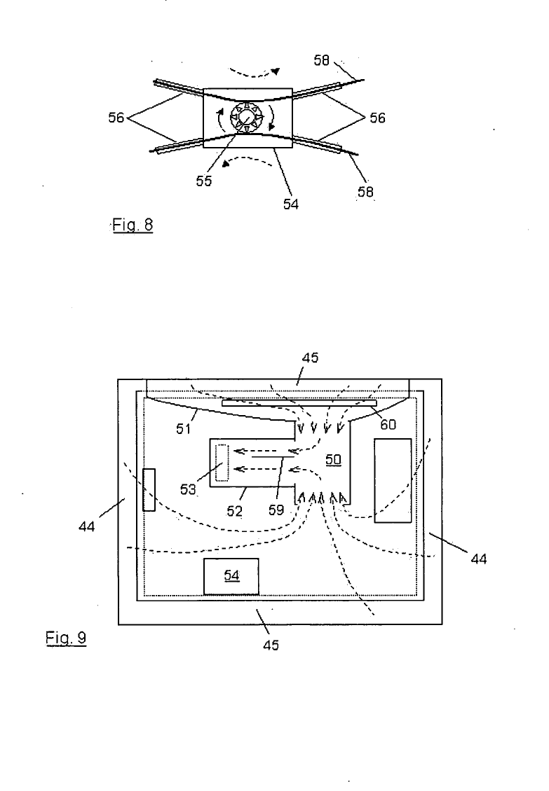

FIG. 8 shows parts of the drive device for a more detailed description;

FIG. 9 shows airflows in the cooking appliance in a simplified plan view similar to FIG. 7;

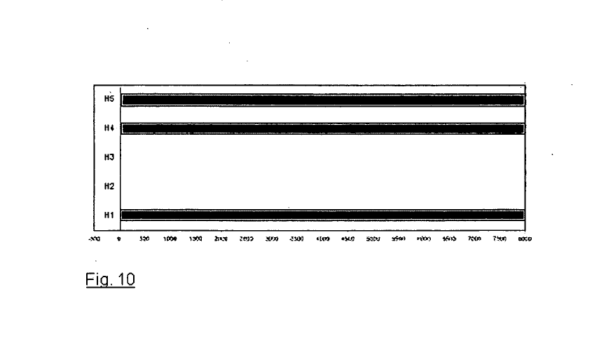

FIG. 10 shows the pulsing of the heating elements during pyrolysis.

The figures are not drawn to scale for better representation of the individual elements.

FIG. 1 shows a cooking appliance which is mounted in an elevated manner with a housing 1. The rear face of the housing 1 is mounted on a wall 2 in the manner of a wall cabinet. Defined in the housing 1 is a cooking compartment 3 which can be monitored by means of a viewing window 4 incorporated in the housing 1. It can be seen from FIG. 4 that the cooking compartment 3 is delimited by a muffle 5 which is provided with a heat-insulating casing which is not shown, and that the muffle 5 has a muffle opening 6 on the base side. The muffle opening 6 can be closed with a base door 7. FIG. 1 shows the base door 7 lowered, the underside of said base door being in contact with a worktop 8 of a kitchen unit. In order to close the cooking compartment 3, the base door 7 must be moved to the position shown in FIG. 2, the so-called “null position”. In order to move the base door 7, the cooking appliance which is mounted in an elevated manner has a drive device 9, 10. The drive device 9, 10 has a drive motor 9 represented in FIGS. 1, 2 and 4 by dashed lines, which is arranged between the muffle 5 and an exterior wall of the housing 1. The drive motor 9 is arranged in the region of the rear face of the housing 1 and, as shown in FIG. 1 or 4, is in active engagement with a pair of lifting elements 10 which are connected to the base door 7. In this connection, according to the schematic side view of FIG. 4, each lifting element 10 is formed as an L-shaped carrier, the vertical arm thereof extending from the drive motor 9 at the side of the housing. In order to move the base door 7, the drive motor 9 can be actuated with the aid of a control panel 12 and a control circuit 13, which according to FIGS. 1 and 2 is arranged on the front of the base door 7. As shown in FIG. 4, the control circuit 13 is located behind the control panel 12 inside the base door 7. The control circuit 13, which in this case is made up of a plurality of spatially and functionally separate printed circuit boards communicating by means of a communication bus, constitutes a central control unit for the operation of the appliance and controls and/or regulates for example the heating, the travel of the base door 3, the implementation of user inputs, the illumination, the anti-trap facility, the pulsing of the heating elements 16, 17, 18, 22 and the like.

It can be seen from FIG. 1 that an upper side of the base door 7 has a cooktop 15. Almost the entire surface of the cooktop 15 is taken up by heating elements 16, 17, 18 which are indicated in FIG. 1 by dotted and dashed lines. In FIG. 1, the heating elements 16, 17 are two hotplate heating elements of different sizes which are spaced apart from one another, while the heating element 18 is a surface heating element provided between the two hotplate heating elements 16, 17, which virtually surrounds the hotplate heating elements 16, 17. The hotplate heating elements 16, 17 define associated cooking zones and/or cooking tops for the user; the hotplate heating elements 16, 17 together with the surface heating element 18 define a bottom heat zone. The zones can be indicated by means of a suitable decorative design on the surface. The heating elements 16, 17, 18 can be respectively controlled by means of the control circuit 13.

In the exemplary embodiment shown, the heating elements 16, 17, 18 are configured as radiant heating elements which are covered by a glass ceramic plate 19. The glass ceramic plate 19 has approximately the dimensions of the upper side of the base door 7. The glass ceramic plate 19 is, moreover, equipped with assembly openings (not shown) through which pedestals project for supporting holders 20 for food shelves 21, as also shown in FIG. 4. Instead of a glass ceramic plate 19, it is also possible to use other—preferably rapid reacting—covers, a thin plate for example.

With the aid of a control toggle provided on the control panel 12 the cooking appliance which is mounted in an elevated manner can be switched to a hotplate operating mode or a bottom heat operating mode, which are described below.

In the hotplate operating mode, the hotplate heating elements 16, 17 can be individually controlled by way of the control circuit 13 by means of control elements 11 which are provided on the control panel 12, while the surface heating element 18 remains out of operation. The hotplate operating mode can be used when the base door 7 is lowered, as is shown in FIG. 1. It can, however, also be operated when the cooking compartment 3 is closed with the base door 7 raised in an energy saving function.

In the bottom heat operating mode, not only the hotplate heating elements 16, 17 but also the surface heating element 18 are controlled by the control device 13.

In order to achieve the most even possible browning of the food during the bottom heat mode, it is crucial that the cooktop 15 providing the bottom heat exhibits an even distribution of the heating power output over the area of the cooktop 15 even though the heating elements 16, 17, 18 have different rated power outputs. Preferably, the heating elements 16, 17, 18 are therefore not switched to continuous operation by the control circuit 13 but the power supply to the heating elements 16, 17, 18 is pulsed. In this situation, the differently rated heating power outputs of the heating elements 16, 17, 18 are reduced individually in such a manner that the heating elements 16, 17, 18 provide an even distribution of the heating power output over the area of the cooktop 15.

FIG. 3 shows schematically the position of a circulating air casing 23 with a circulating air motor and an associated ring heating element, for example for producing hot circulating air during fan-assisted operating mode. The circulating air casing 23 open toward the cooking compartment 3 is separated typically therefrom by a baffle (not shown). Moreover, a top-heat heating element 22 is provided attached to an upper face of the muffle 5, which may be of single-circuit or multi-circuit design, for example with an internal and an external circuit. The different operating modes may also be set using the control circuit 13, such as for example top heat mode, hot air mode or rapid heating mode by a corresponding activation and adjustment of the heating power of the heating elements 16, 17, 18, 22 possibly with activation of the fan 23. The heating power may be adjusted by suitable pulsing. Additionally, the cooktop 15 may also be of variable design, for example with or without browning zones, as pure- single- or multi-circuit-warming zones without cooking zones etc. The housing 1 comprises a seal 24 toward the base door 7.

The control panel 12 is principally arranged on the front side of the base door 7. Alternatively, other arrangements are also conceivable, for example divided up on the front side of the housing 1 into different sub-areas and/or partially on side areas of the cooking appliance. Further configurations are possible. The control elements 11 are not limited as regards their type of construction and can, for example, include control toggles, toggle switches, pushbuttons and membrane keys, the display elements 14 include for example LED, LCD and/or touchscreen displays.

FIG. 5 shows a schematic front view, not to scale, of a cooking appliance which is mounted in an elevated manner in which the open base door 7 is in contact with the worktop 8. The closed state is illustrated in dashed lines.

In this embodiment, two travel switch panels 25 are situated on the front side of the fixedly attached housing 1. Each travel switch panel 25 comprises two pushbuttons, namely an upper CLOSE pushbutton 25a for a base door 7 traveling upward in the closing direction and a lower OPEN pushbutton 25b for a base door 7 traveling downward in the opening direction. In the absence of automatic mode (see below), the base door 7 travels upward only as a result of continuous depression of the CLOSE pushbuttons 25a on both travel switch panels 25, if possible; the base door 7 also travels downward only as a result of continuous depression of the OPEN pushbuttons 25b on both travel switch panels 25, if possible (manual operation). Since increased attentiveness on the part of the user is implicit in manual operation and, in addition, both hands are used here, an anti-trap facility is therefore only optional. In an alternative embodiment, travel switch panels 26 are placed at opposite outer sides of the housing 1 with corresponding CLOSE pushbuttons 26a and OPEN pushbuttons 26b, as illustrated in dotted lines.

The control circuit 13 illustrated in dashed lines, which is located in the interior of the base door 7 behind the control panel 12, switches the drive motor 9 such that the base door 7 drives gently, i.e. not abruptly, by simply turning on the drive motor 9 but by means of a defined ramp.

In this exemplary embodiment the control circuit 13 includes a memory unit 27 for storing at least one target position or travel position P0, P1, P2, PZ of the base door 7, preferably using volatile memory modules, for example DRAMs. If a target position P0, P1, P2, PZ has been stored, after actuation of one of the pushbuttons 25a, 25b or 26a, 26b of the travel switch panels 25 or 26, the base door can travel automatically in the set direction until the next target position has been reached or one of the pushbuttons 25a, 25b or 26a, 26b is actuated again (automatic mode). In this exemplary embodiment the lowest target position PZ corresponds to the maximum opening, the (null) position P0 corresponds to the closed state, and P1 and P2 are freely selectable intermediate positions. If the last target position for a direction has been reached, it is moreover necessary to continue the travel in manual mode, if this is possible (i.e. the last end positions do not correspond to a maximum open end state or to the closed end state). Similarly, if no target position has been stored for one direction—which for example would be the case for an upward movement into the closed position if only PZ is stored and not P0, P1, P2—it is then necessary for the travel in this direction to take place in manual mode. If no target position is stored, for example in the case of a new installation or after a power disconnection, automatic mode is not possible. If the base door 7 travel takes place in automatic mode, then an anti-trap facility is preferably activated.

Automatic mode and manual mode are not mutually exclusive: as a result of continuous actuation of the travel switch panel(s) 25, 26 the base door 7, therefore, also travels in manual mode if it were possible to travel in this direction to a target position. In this situation, it is possible for example to define a maximum actuation time for the travel switch panels 25 and 26, or the associated pushbuttons 25a, 25b and 26a, 26b respectively, for the activation of automatic mode, 0.4 seconds for example.

A target position P0, P1, P2, PZ can be any position of the base door 7 between and including the null position P0 and the maximum opening position PZ. The maximum stored opening position PZ does not, however, need to be the position in contact with the worktop 8. Storing of the target position P0, P1, P2, PZ can be performed with the base door 7 in the desired target position P0, P1, P2, PZ, by means of, for example, actuating a confirmation pushbutton 28 on the control panel 12 for several seconds (lasting two seconds, for example). Existing optical and/or acoustic signal generators which output corresponding signals after storage of a target position are not illustrated in order to improve clarity. Travel to the desired target position P0, P1, P2, PZ to be selected takes place, for example, as a result—in this embodiment—of two-handed operation of the travel switch panels 25 and/or 26 and manual travel to this position.

The memory unit 27 can store only one or, as shown in this exemplary embodiment, even a plurality of target positions P0, P1, P2, PZ. In the case of a plurality of target positions P0, P1, P2, PZ, these can be reached in sequence by actuating the corresponding travel pushbuttons 25a, 25b and 26a, 26b. By having a plurality of target positions P0, P1, P2, PZ, the cooking appliance which is mounted in an elevated manner can be conveniently adapted to the desired operating height for a plurality of users. The target position(s) can advantageously be deleted and/or overwritten. In one embodiment, for example, only one target position can be stored in the open state, while the null position P0 is detected automatically and can be reached automatically. Alternatively, the null position P0 must also be stored in order for it to be automatically reachable.

It is particularly advantageous for ergonomic use, if the or a target position P1, P2, PZ opens the base door 7 at least approx. 400 mm to approx. 540 mm (in other words P1-P0, P2-P0, PZ-P0≧40 cm to 54 cm). Given this opening dimension, the food shelves 21 can be simply inserted into the holders 20. In this situation, it is advantageous if the viewing window 4 is mounted approximately at, or slightly below, the eye level of the user, for example by using a template which indicates the dimensions of the cooking appliance.

Not illustrated is a power outage bridging facility, provided for bridging a power outage of approx. 1 to 3 s, preferably up to 1.5 s.

The drive motor 9 from FIG. 1 has at least one sensor unit 31, 32 arranged on a motor shaft 30, before or after a gear mechanism where applicable, in order to measure a travel path or a position and/or a speed of the base door 7. The sensor unit can, for example, comprise one or more induction sensors, Hall sensors, opto-sensors, SAW sensors and so forth. In this situation, in order to perform simple distance and speed measurement, two Hall (part) elements 31 are fitted here, displaced by 180°—i.e. opposite one another—on the motor shaft 30, and a Hall measuring sensor 32 is fitted at a fixed distance in this region of the motor shaft. If a Hall element 31 then travels past the measuring sensor 32 when the motor shaft 30 is rotating, a measurement or sensor signal is produced which is digital to a good approximation. With (not necessarily) two Hall elements 31, two signals are thus output during a rotation of the motor shaft 30. By carrying out a timing assessment of these signals, their time difference, for example, the speed vL of the base door 7, can be determined, for example by using comparison tables or a conversion into real time in the control circuit 13. By means of the addition and/or subtraction of the measurement signals it is possible to determine a travel path and/or a position of the base door 7.

A speed regulation facility can implement the speed, for example by means of a PWM-controlled power semiconductor.

For the purpose of null point determination, the travel path measurement is automatically newly adjusted by initialization in the null position P0 of the base door 7 each time it starts to travel, in order for example to prevent an incorrect sensor signal output and/or recording from being passed on.

The drive motor 9 can be operated by actuating both travel switch panels 25 and/or 26 even if the main switch 29 is turned off.

Instead of two separate switches per travel switch panel 25, 26, one individual switch per travel switch panel is also possible, for example a toggle switch with a neutral position which switches only under pressure. Other forms are also possible. There is also no restriction to the type and arrangement of the control elements 28, 29 on the control panel 12.

In this situation, the arrangement and distribution of the control circuit 13 is flexible and not restricted, in other words it can also comprise a plurality of boards, for example a display board, a control board and a lift board which are spatially separated.

A 4 mm opening dimension can be detected by limit switches 33 which deactivate an anti-trap facility when actuated.

The cooking appliance which is mounted in an elevated manner can also be implemented without a memory unit 27, as a result of which no automatic mode is then possible. This can be useful for increased operational safety, for example to protect against trapping.

FIG. 6 shows, in a manner which is schematically indicated (not to scale) from the front, the position of individual elements of the housing 1 in the closed state, in which the base door 7 is sealingly positioned on the muffle 5 and thus also visually seals the housing 1. The housing 1 consists of an (internal) housing body 34 (shown in dashed lines) and a housing cover and/or panel 35, which surrounds the housing body 34 at least to the front and to the side. The intermediate space 36 between the housing body 34 and the housing cover 35 is designed such that cool air may at least partially flow through. To this end, lower ventilation openings 37, for example ventilation slots, are provided in the housing cover 35 which are attached lower down than the upper surface 38 of the housing body 34, preferably in a region in the vicinity of the muffle opening and/or of the raised floor 7. The ventilation openings 37 are in this case incorporated on the lower face of the housing cover 35; but may, for example, be provided to the sides. Accordingly, one or more upper ventilation openings 39, for example a ventilation slot, are located in the upper part of the housing cover 35, specifically in the top thereof. As a result, an airflow consisting of cool air may be created through the intermediate space 36, typically from bottom to top, which then is dissipated through the top.

The muffle 5 is incorporated in the housing body 34 (shown in dotted lines), the associated intermediate space 40—as far as the front face—being clad with insulating material. The muffle 5 is inversely U-shaped. In order to be able to see into the cooking compartment 3, a plurality of viewing windows 4 are present, namely a first (internal) viewing window 41 directly covering the muffle 5 (illustrated in dotted and dashed lines), which therefore partially represents a wall of the muffle 5, moreover a second (central) viewing window 42 held by the housing body 34 (also indicated in dash-dotted lines) and a third (external) viewing window 43 in the housing cover 35.

Optionally, further intermediate windows may be inserted (not shown) which preferably are fastened to the housing body 34, or fewer viewing windows 4 may be present, for example only the internal and the external viewing windows 41, 43. For example, the ventilation slots 37, 39 may be incorporated in a different arrangement and shape.

FIG. 7 shows in a plan view of the housing 1 according to the plane of section III-III of FIG. 6 (i.e. without the upper housing wall) a detailed, not to scale, view of the housing interior with different elements arranged therein. From this viewpoint, the intermediate spaces 36 are easily visible between the housing body 34 and the housing cover 35, namely the lateral intermediate spaces 44, the front intermediate space 45 and the rear intermediate space 46. Due to the three viewing windows 41, 42, 43, the front intermediate space 45 is subdivided vertically into a first front intermediate space 45a between the central viewing window 42 and the external viewing window 43 and a second front intermediate space 45b between the central viewing window 42 and the internal viewing window 41. Naturally, the intermediate spaces do not have to be empty, but may have different elements therein, such as for example lifting elements 10, holders, through-passages, insulation, air conduction elements, such as air guides, screws, struts, etc., not every intermediate space 36 having to permit a large airflow.

On the housing body 34 are attached, in particular: electrical and/or electronic sub-assemblies 47 such as the control circuit 13, a drive device 48 and a ventilation device 49.

The ventilation device 49 comprises at least one fan, which in this embodiment is specifically a fan which draws in air from two directions by means of two suction openings.

To this end, advantageously, a two-part fan is used, in which additionally the exhaust air is discharged at least substantially unmixed. Particularly suitable is the double radial fan 50 shown in this case, which comprises two opposing suction openings and discharges drawn-in air to the side. In this case, the two drawn-in airflows are discharged parallel to one another substantially to the side.

In the design shown here, a suction opening of the double radial fan 50 is connected to a suction channel 51, which covers the front intermediate space 45 from above at least partially, and as a result during operation draws in cool air from below from the lower ventilation openings 37 through the front intermediate space 45. As a result, the front intermediate space 45 is cooled for improved user safety, which due to the viewing window 4, 41-43 provides rather low thermal insulation.

The other (rear) suction opening of the double radial fan 50 is open. As a result, cool air is drawn in, in particular from the lateral intermediate spaces 44 and the rear intermediate space 46 and flows over the upper surface 38 toward the fan 50. As a result, air flows around and/or through the components arranged on the upper surface 38 and thus said components are cooled. This is advantageous, in particular, for the electronic modules 47.

The exhaust air of the fan 50 flows through an air outlet channel 52 to an upper air outlet 53 which blows out the air through the ventilation opening(s) 39 of FIG. 6.

The drive device 48 comprises a motor 9 centrally fastened to the upper face 38 of the housing body 34, on which a guide housing 54 rests. Through the guide housing 54 run two guide channels (not shown). The guide housing 54 has a circular recess for inserting a pinion 55 of the motor 9. The open guide channels run past the side of the recess so that ropes, cables, etc. located in the guide channels are brought into engagement with the pinion 55. On the outer openings of the guide channels, i.e. in this case on four openings, guide tubes 56 are attached which together with the guide channels form continuous cable channels. The guide tubes 56 extend in this embodiment from the guide housing 54 as far as the edge of the upper surface 38 in a region above the lifting elements 10 and further over the edge down into the lifting elements 10.

In each of the two cable channels runs a pitched cable as a drive cable (not shown). The pitched cable has a flexible metal core and is sheathed with wire. One end of each pitched cable is fixedly connected to the base door 7, the other end is free. As both pitched cables on opposing sides are in engagement with the pinion 55, they are displaced in a linear manner by rotating the pinion 55 in opposing directions. The pitched cable drive may, for example, be obtained from the company WEBASTO, Germany.

The guide tubes 56 are elastically deformable and, for example, formed from an aluminum injection molding. At least one load bearing guide tube 56 (i.e. a guide tube 56, which guides a portion of a pitched cable which is fixedly connected to the base door 7—directly or indirectly; as a result a load bears against this portion of the pitched cable) rests on a support 57, the bearing force being dependent on the size of the load on the pitched cable. In this embodiment, such a support 57 is provided for each load-guiding guide tube 56. The supports 57 are located substantially at the edge of the upper surface 38 of the housing body 34 so that the length which may be deflected under load—the “arm”—of the guide tube 56 is considerable. As a result, the load impact effect of the substantially perpendicular force exerted by the respective guide tube 56 on the support 57, is designed to be as large as possible. The bearing force is, for example, dependent on the loading of the base door 7, or positioning on a base or an object. By measuring the bearing force, for example, an overload of the base door 7 or an anti-trap facility may be implemented.

The length of the guide tube 56 is a design choice and may be comparatively short or reach the base door 7 (in the closed state) for fastening the pitched cable.

In order to use the support of the pitched cable for load measurement, the use of guide tubes 56 is advantageous, namely for reasons of slippage and abrasion, but not absolutely necessary. It is also possible to guide the pitched cable—or generally cables or ropes—freely over suitably positioned supports (for example reaching over the edge of the surface). The supports are thus advantageously accordingly designed, for example produced from a suitably hard and/or slidable material, which has been surface treated or surface coated.

The use of a pitched cable drive is not obligatory but is advantageous due to the simple construction and assembly as well as the accurate displacement. Alternative drives include, for example, those with a drive of a cable drum, etc.

FIG. 8 shows, for a more accurate description of the drive principle, in plan view the guide housing 54 with the attached guide tubes 56 which form two separate guide channels, namely—in this view—an upper and a lower guide channel. In each of the guide channels 54, 56 runs a pitched cable 58, typically of a length in the region of a meter. The guide channels guide the pitched cable 58 to a recess in the guide housing 54, through which a gear wheel and/or pinion 55 driven by a drive motor is inserted. The teeth of the pinion 55 are in engagement with the covered wire of the respective pitched cable 58 which with regard to the pinion 55 forms a type of linear sequence of teeth.

By rotating the pinion 55 by means of the drive motor—in this case shown clockwise by the continuous arrows—the upper pitched cable 58 is displaced in a linear manner from left to right and the lower cable 58 is displaced to the same extent from right to left, as indicated by the dashed arrows.

As the pitched cables 58 are in permanent engagement with the pinion 55 and thus continuously coupled to the drive motor, an effective locking of the base door is also achieved in the opening direction, for example for protection from opening a hot cooking compartment, for example during pyrolysis, or with an activated child safety device. For door locking, a mechanical lock has been hitherto used which, depending on specific parameters such as a threshold temperature etc., the door is closed typically by means of a locking hook. Such a lock may, however, be dispensed with when the drive motor, for example according to reference numeral 9 of FIG. 7, drives the pinion 55 via a self-locking gear mechanism (not shown). If the drive motor is switched off—which preferably occurs as a result of a power disconnection and deactivation of direction switches—for opening the cooking compartment, or generally for moving the base door, a mechanical force and an induction force of the drive motor have to be overcome. The force applied thereto has to be greater, the higher the gear ratio. For the embodiment shown, a gear ratio in the range of 30:1 to 60:1 has proved a good compromise between self-locking and travel speed. In particular a gear ratio of 40:1 to 50:1, specifically of 45:1, is suitable. With a gear ratio of 45 the base door may not be opened with a load of more than 20 kg.

One of a plurality of possible embodiments of the gear mechanism is a worm gear. Other types of gear mechanism are known to the person skilled to the art from mechanical engineering.

Naturally, the gear ratio is not restricted to this range, but may be adapted by the person skilled in the art, for example to the specifications of the drive motor used, the mechanical friction of the actuating mechanism of the base door, the type of drive (pitched cable, cable drum, etc.) the weight and the loading of the base door and the like.

FIG. 9 shows a simplified diagram similar to FIG. 7 with air movements schematically illustrated by dashed arrows. In this case, for a better overview, the fan 50, suction channel 51 and air outlet channel 52 are shown without covers.

Air is drawn up through the rear opening, in this case on the wall of the (double radial) fan 50 from the lateral intermediate spaces 44 and the rear intermediate space 46 and at the same time is also guided over the electronic unit 47 for cooling. Through the front opening of the fan 50 air is drawn up from the—in this case two-part—front intermediate space 45 by means of a suction channel 51 connected via the intermediate space 45. The airflows are then respectively blown into and through the air outlet channel 52 at the sides and then blown outside through the air outlet 53. The exhaust air moving substantially parallel—i.e. not mixed together—in the double radial fan 50 is kept separate by a flow divider 59 and/or a partition in the air outlet channel 52 at least over this distance. The projection of the air outlet 53 is shown in dotted lines. In this figure, a vapor flap 60 is also visible which may be actuated and which, if required, opens and closes a vapor opening of the cooking compartment 3.

FIG. 10 shows a possibility of pulsing the heating elements for a pyrolysis mode (automatic self-cleaning). The duration of a heating cycle of 80 seconds at intervals of 1/100s is plotted on the abscissa, and on the ordinate the differently activated heating elements H1-H5. In this case, the heating elements are denoted as follows: H1 is the internal heating circuit of a two circuit top-heat heating element (which is attached to the cover of the muffle), H2 is the inner heating circuit of a two circuit bottom-heat heating element present in the cooktop, H3 is the outer heating circuit of the two circuit bottom-heat heating element, H4 is a ring heating element which is attached to the air circulator on the rear wall of the muffle and H5 is the outer heating circuit of the two circuit top-heat heating element.

It is recognized that the bottom-heat heating element H2, H3 is not active during pyrolytic self-cleaning. The other heating elements H1, H4, H5 are operated at the respective maximum output Pmax (Pmax (H1)=1500 W; Pmax (H4)=900 W; Pmax (H5)=1200 W). The pyrolysis heating power of all heating elements is thus 3.6 KW which corresponds to the maximum possible heating power of the appliance. In pyrolysis mode, moreover, the air circulator (not shown) is in operation, in order to fill the cooking compartment as uniformly as possible with hot air.

During this pulsing and/or power distribution the cooking compartment and/or the muffle is heated to approximately 475° C.±15° C. In this embodiment, three time intervals may be set, namely of 60 minutes, 75 minutes and 90 minutes. After reaching the desired pyrolysis temperature, the pyrolysis heating power of all heating elements is reduced to such an extent that the pyrolysis temperature is maintained (which additionally may be set at intervals according to the degree of soiling), and namely in this case (not necessarily generally) by maintaining the relative heating powers of the heating elements H1-H5. The pyrolysis heating power is thus below 3.6 KW with the same relative distribution of the heating powers to the heating elements.

The heat, in particular by the radiation of the top heat element and/or the top-heat heating element H1, H5, is such that the residue in the cooking compartment is completely incinerated even without bottom heat H2, H3.

When, during the pyrolysis, an accessory is intended to be cleaned therewith, positioning the accessory in the middle of the cooking compartment has proved advantageous.

In pyrolysis mode, the base door is locked during heating at a temperature in the cooking compartment of 350° C. The locking in this case occurs by using the self-locking gear mechanism and short circuiting of the drive motor. During cooling, the base door is unlocked at a cooking compartment temperature of 200° C.

### LIST OF REFERENCE NUMERALS

| | |
|---|---|
| 1 | Housing |
| 2 | Wall |
| 3 | Cooking compartment |
| 4 | Viewing window |
| 5 | Muffle |
| 6 | Muffle opening |
| 7 | Base door |
| 8 | Worktop |
| 9 | Drive motor |
| 10 | Lifting element |
| 11 | Control element |
| 12 | Control panel |
| 13 | Control circuit |
| 14 | Display elements |
| 15 | Cooktop |
| 16 | Hotplate heating element |
| 17 | Hotplate heating element |
| 18 | Surface heating element |
| 19 | Glass ceramic plate |
| 20 | Holder |
| 21 | Food shelf |
| 22 | Top-heat heating element |
| 23 | Fan |
| 24 | Seal |
| 25 | Travel switch panel |
| 25a | Travel switch panel up |
| 25b | Travel switch panel down |
| 26 | Travel switch panel |
| 26a | Travel switch panel up |
| 26b | Travel switch panel down |
| 27 | Memory unit |
| 28 | Actuating button |
| 29 | Main switch |
| 30 | Motor shaft |
| 31 | Hall element |
| 32 | Measuring sensor |
| 33 | Limit switch |
| 34 | Housing body |
| 35 | Housing cover |
| 36 | Intermediate space |
| 37 | Lower ventilation openings |
| 38 | Upper surface of the housing body (34) |
| 39 | Upper ventilation opening |
| 40 | Intermediate space |
| 41 | First (internal) viewing window |
| 42 | Second (central) viewing window |
| 43 | Third (external) viewing window |
| 44 | Lateral intermediate spaces |
| 45 | Front intermediate space |
| 45a | First front intermediate space |
| 45b | Second front intermediate space |
| 46 | Rear intermediate space |
| 47 | Electric and/or electronic sub-assemblies |
| 48 | Drive device |
| 49 | Ventilation device |
| 50 | Fan |
| 51 | Suction channel |
| 52 | Air outlet channel |
| 53 | Air outlet |
| 54 | Guide housing |
| 55 | Gear wheel |
| 56 | Guide tubes |
| 57 | Support |
| 58 | Pitched cable |
| 59 | Flow divider |
| 60 | Vapor flap |
| H1 | Top-heat heating element internal |
| H2 | Bottom-heat heating element internal |
| H3 | Bottom-heat heating element external |
| H4 | Ring heating element |
| H5 | Top-heat heating element external |
| P0 | Null position |
| P1 | Intermediate position |
| P2 | Intermediate position |
| PZ | End position |

1-15. (canceled)

16. A cooking appliance which is mounted in an elevated manner, comprising:
at least one muffle defining a cooking compartment; the muffle having an open base side defining a muffle opening;
a base door for closing the muffle opening;
at least one heating element in the muffle;
the cooking compartment adapted to be cleaned by pyrolysis from heat generated by at least one heating element; wherein pyrolysis heating power generated by the base door does not exceed 20% of the total pyrolysis heating power generated in the cooking compartment.

17. The cooking appliance which is mounted in an elevated manner as claimed in claim 16, wherein the pyrolysis heating power generated by the base door does not exceed 10% of the total pyrolysis heating power generated in the cooking compartment.

18. The cooking appliance which is mounted in an elevated manner as claimed in claim 16, wherein the pyrolysis heating power generated by the base door does not exceed 5% of the total pyrolysis heating power generated in the cooking compartment.

19. The cooking appliance which is mounted in an elevated manner as claimed in claim 16, further including a plurality of heating elements in the muffle; wherein the heating elements in the muffle are the only heating elements used for pyrolysis.

20. The cooking appliance which is mounted in an elevated manner as claimed claim 16, further including a top-heat heating element; the top-heat heating element is the only heating element used for pyrolysis.

21. The cooking appliance which is mounted in an elevated manner as claimed in claim 16, further including a top-heat heating element and a ring heating element located in the muffle; the top-heat heating element and the ring heating element being used for pyrolysis.

22. The cooking appliance which is mounted in an elevated manner as claimed claim 16, further including a circulating air motor; the circulating air motor being activated during pyrolysis.

23. The cooking appliance which is mounted in an elevated manner as claimed in claim 16 wherein the maximum total pyrolysis heating power is between 3 and 4 KW.

24. The cooking appliance which is mounted in an elevated manner as claimed in claim 23 wherein the maximum total pyrolysis heating power is 3.6 KW.

25. The cooking appliance which is mounted in an elevated manner as claimed in claim 16 wherein the nominal temperature in the cooking compartment is at least 425° C. during pyrolysis.

26. The cooking appliance which is mounted in an elevated manner as claimed in claim 25 wherein the nominal temperature in the cooking compartment is 475° C. during pyrolysis.

27. The cooking appliance which is mounted in an elevated manner as claimed in claim 16, further including a locking mechansim for locking the closed base door during pyrolysis.

28. The cooking appliance which is mounted in an elevated manner as claimed in claim 27, wherein the locking mechanism is a self-locking gear mechanism on the drive motor.

29. The cooking appliance which is mounted in an elevated maner as claimed in claim 28 wherein the gear ratio of the self-locking gear mechanism is between 30:1 and 60:1.

30. The cooking appliance which is mounted in an elevated manner as claimed in claim 27 wherein the base door is locked during heating after reaching a first temperature threshold and is unlocked during cooling after reaching a second temperature threshold.

31. The cooking appliance which is mounted in an elevated manner as claimed in claim 16, further including a vapor outlet and a vapor flap; the vapor flap closes the vapor outlet during pyrolysis.

32. The cooking appliance which is mounted in an elevated manner as claimed in claim 16, further including a plurality of heating elements; wherein the heating power of the heating elements is pulsed.

33. A method for operating a cooking appliance which is mounted in an elevated manner, which includes at least one muffle defining a cooking compartment, the muffle having an open base side defining a muffle opening, a base door for closing the muffle opening, at least one heating element in the muffle, the cooking compartment adapted to be cleaned by pyrolysis from heat generated by at least one heating element, comprising:
operating at least one heating element at maximum total pyrolysis heating power beginning at the start of pyrolysis until a nominal temperature is reached; and
operating at least one heating element at reduced pyrolysis power after the nominal temperature is reached for maintaining the nominal temperature.
